(19) United States
(12) Patent Application Publication
(10) Pub. No.: US 2022/0263217 A1
(43) Pub. Date: Aug. 18, 2022

(54) SINGLE GLASS ANTENNA STRUCTURE

(71) Applicants: Hyundai Motor Company, Seoul (KR); Kia Corporation, Seoul (KR); Hongik University Industry-Academia Cooperation Foundation, Seoul (KR)

(72) Inventors: Nak Kyoung Kong, Seongnam (KR); Dae Hee Lee, Incheon (KR); Ki Hong Lee, Seoul (KR); Jong Min Park, Seoul (KR); Ho Sung Choo, Seoul (KR); Do Young Jang, Seoul (KR); Sang Woon Youn, Anyang (KR)

(21) Appl. No.: 17/523,483

(22) Filed: Nov. 10, 2021

(30) Foreign Application Priority Data
Feb. 18, 2021 (KR) 10-2021-0021958

(51) Int. Cl. H01Q 1/12; H01Q 1/32; H01Q 21/28

(52) U.S. Cl. CPC H01Q 1/1271; H01Q 21/28; H01Q 1/3275

(57) ABSTRACT

A single glass antenna structure includes a glass that is disposed on a vehicle and a plurality of monopole antenna units that are disposed on one surface of the glass to be adjacent to each other. Each of the monopole antenna units includes a transmission line extending in a first direction of the glass and at least one monopole device located along the transmission line.

### CROSS-REFERENCE TO RELATED APPLICATION

This application claims, under 35 U.S.C. § 119(a), the benefit of priority to Korean Patent Application No. 10-2021-0021958 filed on Feb. 18, 2021, the entire contents of which are incorporated herein by reference.

### BACKGROUND

### (a) Technical Field

The present disclosure relates to a single glass antenna structure, and more particularly to a single glass including a printed antenna configured in consideration of reflection coefficient, efficiency, and gain in the state in which aesthetics of a vehicle are maintained.

### (b) Background Art

In recent years, demand for vehicles has increased dramatically. With increase in demand for vehicles and in the actual number of vehicles that people possess, traffic accidents are increasing in proportion thereto.

One of the main causes of the traffic accidents is careless driving, and wireless access in vehicular environments (WAVE) communication has come to the forefront as a solution capable of reducing the number of traffic accidents due to careless driving. In particular, WAVE, which is a next-generation vehicular communication environment, is an important element of vehicle-to-vehicle high-speed communication (V2V) and vehicle-to-infrastructure communication (V2I).

Furthermore, in recent years, 5G communication technology capable of enabling a vehicle to collect a substantial amount of data, such as driving information of other vehicles, surrounding traffic information, and pedestrian information, to improve a driving environment has been spotlighted. When a communication antenna is mounted to a vehicle, glass antenna technology for printing an antenna pattern on the glass of the vehicle is used to minimize a space necessary for mounting and to maintain aesthetics. Since the current glass antenna is designed for AM and FM reception, however, new antenna design technology for a 5G band is required.

Tests for applying the WAVE communication technology to vehicles or tests for realizing the WAVE communication technology in large vehicles, such as buses, in a highway environment have been actively conducted. It is possible to realize WAVE through a shark antenna installed on a general vehicle. However, the shark antenna is installed outside the vehicle, whereby the installation thereof is difficult and the installation structure thereof is complicated

The above information disclosed in this section is provided merely for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with the prior art. It is an object of the present invention to provide a single glass antenna structure including a plurality of monopole antenna units located on one surface of a glass. It is another object of the present invention to provide a single glass antenna structure configured such that the size of each monopole antenna unit is optimized.

The objects of the present invention are not limited to that described above. The objects of the present invention will be clearly understood from the following description of embodiments and could be implemented by means defined in the claims and a combination thereof.

In order to accomplish the above objects, a single glass antenna structure according to the present invention includes the following construction. In one aspect, the single glass antenna structure may include a glass located at a vehicle and a plurality of monopole antenna units located on one surface of the glass to be adjacent to each other, wherein each of the monopole antenna units includes a transmission line that extends in a first direction of the glass and at least one monopole device located along the transmission line.

In addition, the single glass antenna structure may further include a connector located at one end of the transmission line. The single glass antenna structure may further include a CPW-fed structure fastened to the connector and a coating layer located on the rear surface of the glass, on which the monopole antenna units are printed.

Each of the monopole antenna units may include four monopole devices located along the transmission line to be spaced apart from each other by the same distance. In addition, a second-direction width of the transmission line may be ¼ or less of a second-direction width of the monopole device. A first-direction length of the monopole device may be ⅓ or less of the wavelength of a frequency transmitted and received through the monopole antenna units. The glass may have a thickness of about 2.9 mm to 3.3 mm. In addition, the glass may have a relative permittivity of about 6.8 to 7.1. Four monopole antenna units may be located adjacent to each other to be spaced apart from each other by the same distance.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated in the accompanying drawings which are given hereinbelow by way of illustration only, and thus are not limitative of the present invention, and wherein:

FIG. 1 is a sectional view of a single glass antenna structure as an embodiment of the present invention;

FIG. 2 is an enlarged view of a monopole antenna unit as an embodiment of the present invention;

FIG. 3 is a front view of a glass including a plurality of monopole antenna units as an embodiment of the present invention;

FIG. 4 shows data of front gain values based on glass thickness as an embodiment of the present invention;

FIG. 5 shows data of front gain values based on first-direction length of a monopole device as an embodiment of the present invention;

FIG. 6 shows data of front gain values based on second-direction length of the monopole device as an embodiment of the present invention;

FIG. 7 shows data of front gain values based on length of a transmission line as an embodiment of the present invention; and

FIG. 8 shows data of front gain values based on second-direction length of a transmission line as an embodiment of the present invention.

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes, will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention, examples of which are illustrated in the accompanying drawings and described below. However, the present invention may be embodied in many different forms and should not be construed as limited to the embodiments set forth herein. Rather, these embodiments are provided so that the present invention will be thorough and complete, and will fully convey the scope of the present invention to those skilled in the art. The embodiments are merely given to make the disclosure of the present invention perfect to those skilled in the art.

The term “device,” “line,” “unit,” or “glass” used in this specification signifies one unit that processes at least one function or operation, and may be realized by hardware, software, or a combination thereof. In addition, the terms “first direction” and “second direction” are used in this specification to distinguish between the same elements, and the first direction and the second direction have an angle of 90 degrees therebetween. Furthermore, in an embodiment of the present invention, the first direction may be interpreted to have the same meaning as the longitudinal direction, and the second direction may be interpreted to have the same meaning as the lateral direction. Also, when the terms “front” and “rear” are used in this specification to distinguish between elements, the front means the outward direction of a vehicle based on one surface of a glass 100, and the rear means the direction toward the interior of the vehicle.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Hereinafter, embodiments will be described in detail with reference to the accompanying drawings. In describing the embodiments with reference to the accompanying drawings, identical or corresponding components are denoted by the same reference numerals, and a duplicate description thereof will be omitted.

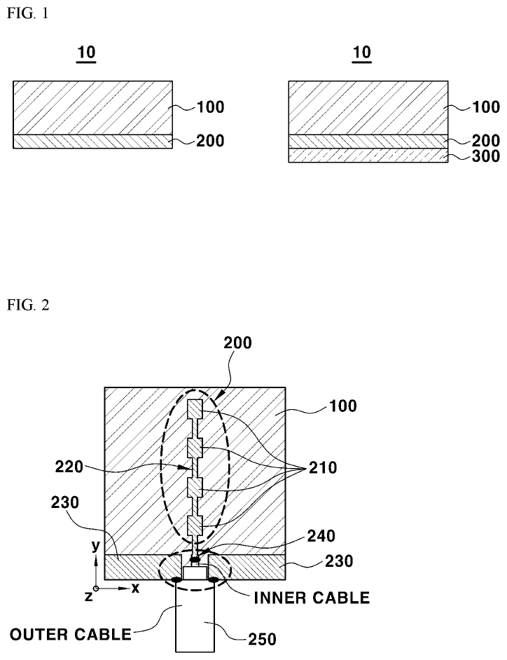

FIGS. 1 and 2 show a single glass antenna structure 10 as an embodiment of the present invention. As shown, the single glass antenna structure 10 may include a glass 100 disposed to face the outside of a vehicle and a monopole antenna unit 200 disposed on at least a portion of the lower surface of the glass 100.

In an embodiment of the present invention, the glass 100 may be made of soda-lime glass, and one surface of the glass 100, which is a base of a substrate, is configured to allow the monopole antenna unit 200 to be printed thereon. The glass 100 may be configured to have a relative permittivity of about 7.0. More preferably, the glass 100 according to the present invention is configured to have a relative permittivity of about 6.8 to 7.1

The monopole antenna unit 200 may be disposed on one surface of the glass 100. More preferably, in an embodiment of the present invention, the monopole antenna unit 200 may be disposed at the upper end or the lower end of a windshield glass 100. In addition, the monopole antenna unit 200 may include a connector 240 for feeding to a vehicle. The connector 240 is configured to have a coplanar waveguide (CPW)-fed structure, and may be disposed at one end of the glass 100 for feeding to the vehicle. In other words, one end of the glass 100 and the tip end of the monopole antenna unit 200 coincide with each other to transmit and receive an electrical signal to and from the vehicle.

In an embodiment of the present invention, the monopole antenna unit 200 may include a transmission line 220 that extends in one direction of the glass 100 and at least one quadrangular monopole device 210 located along the transmission line 220. Furthermore, the transmission line 220 may extend from one end of the glass 100 in a first direction, and a plurality of monopole devices 210 may be located along the transmission line 220 to be spaced apart from each other by the same distance. More preferably, four monopole antenna units 200 may be spaced apart from each other by the same distance in a second direction, and each of the monopole antenna units 200 is configured such that four monopole devices 210 are located along the transmission line 220 to be spaced apart from each other by the same distance.

The longitudinal length (e.g., height or first-direction length) and the lateral length (e.g., width or second-direction length) of the monopole device 210 of the monopole antenna unit 200 and the relative permittivity of the glass 100 act as design variables. At this time, the monopole device 210 may have the maximum front gain while resonating at 28 GHz. The monopole antenna unit 200 may be printed on one surface of the glass 100 by laser processing or silk screening, and the material for the monopole antenna unit 200 may be a mixture of copper and silver, each of which is electrically conductive, or a material including silver.

A coating layer 300 may be provided to wrap the upper end of one surface of the glass 100, on which the monopole antenna unit 200 is printed. The coating layer 300 may be deposited to have physical properties capable of preventing physical damage to the monopole antenna unit 200 printed on one surface of the glass 100. More preferably, a fluorine-based coating agent, an epoxy-based coating agent, or a silicone coating agent is used to form the coating layer 300. For example, OS-210HF or DS-530Z may be used.

The monopole antenna unit 200 may be disposed at one end of the glass 100 in the state in which a portion thereof is open. The connector 240 may be provided at the open end of the monopole antenna unit 200 for connection with the vehicle via a cable. In an embodiment of the present invention, the connector 240 and the cable may include a CPW-fed structure 250 (coplanar waveguide-fed structure) for feeding an electrical signal. The CPW-fed structure 250 may include a transmission line 220 of the monopole antenna unit 200, grounds 230 disposed at opposite sides of the transmission line 220 in parallel, and a space between each ground 230 and the transmission line 220. At this time, the width of an extension line is configured to be less than the width of the monopole device 210 in consideration of the size of the monopole device 210. The grounds 230 may be disposed at opposite sides of the glass at which the transmission line 220 is located to be spaced apart from each other. More preferably, each ground 230 may be disposed on the glass 100 to have a first-direction length of about 3 mm.

Additionally, in the present invention, the CPW-fed structure 250 may be configured to perform feeding in a 5G frequency band (28 mmWave band). More preferably, two or more monolayer planar printed monopole devices 210 linearly arranged along the transmission line include at least one CPW-fed structure 250. The CPW-fed structure 250 according to the present invention may be connected to a cable that extends from a power supply source mounted in the vehicle. A common coaxial cable may be used as the power cable. However, the present invention is not limited as to the type of the cable as long as the cable exhibits excellent transmission properties and has an inner core (+) and an outer cover (1) definitely separated from each other. In the CPW-fed structure 250, the line may be connected to the inner core of the cable, and the grounds 230 may be connected to the outer cover of the cable. Connection may be performed by soldering or other different electrical connection means having the same function.

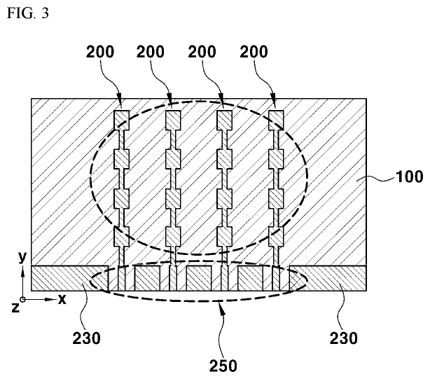

FIG. 3 shows an embodiment in which four monopole antenna units 200, each of which includes four monopole devices 210, are arranged as an embodiment of the present invention.

Each monopole antenna unit 200 may be printed on the rear surface of the glass 100, which serves as a base, and may include four monopole devices 210 spaced apart from each other in the first direction. Furthermore, the four monopole antenna units 200, each of which includes four monopole devices 210, may be spaced apart from each other in the second direction. The tip end of each monopole antenna unit 200 may be fastened to the vehicle via the CPW-fed structure 250 for feeding.

In an embodiment of the present invention, the glass 100 may have a thickness of about 2.9 mm to 3.3 mm, the monopole device 210 may have a height-direction length equivalent to about ⅓ of the wavelength of an mmWave frequency (28G frequency) in a 5G frequency band, and the monopole device 210 may have a lateral-direction length of about 1.7 mm to 1.9 mm. More preferably, the height-direction length of the monopole device 210 may be about 2.7 mm to 2.9 mm.

Additionally, in an embodiment of the present invention, the length of a transmission line 220 between adjacent ones of the monopole devices 210 may be less than about ¼ of the second-direction length of the monopole device. In an embodiment of the present invention, the height-direction length of the transmission line 220 between the adjacent monopole devices 210 may be about 0.6 mm to 0.8 mm. Furthermore, the transmission line 220 may have a width of about 0.3 mm to 0.5 mm.

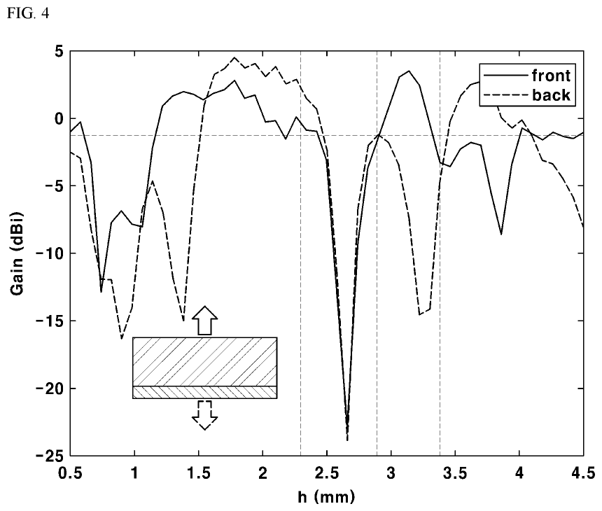

FIGS. 4 to 8 show antenna gain data based on glass thickness, antenna gain data in the first-direction length of the monopole device 210, antenna gain data in the second-direction width of the monopole device 210, antenna gain data corresponding to the first-direction length of the transmission line 220, and antenna gain data corresponding to the second-direction width of the transmission line 220 as an embodiment of the present invention.

In an embodiment of the present invention, the first-direction length of the monopole device 210 is set to 2.8 mm, the second-direction length of the monopole device 210 is set to 1.8 mm, the first-direction length of the transmission line 220 is set to 0.4 mm, the first-direction length of the transmission line 220 located between the adjacent monopole devices 210 is set to 0.7 mm, the second-direction length of the connector 240 at the tip end of the transmission line 220 fastened to the CPW-fed structure 250 is set to 0.5 mm, the second-direction distance between the extension of the transmission line 220 and each ground 230 of the CPW-fed structure 250 is set to 0.0792 mm, and the first-direction width of each ground 230 is set to 3 mm. Furthermore, data of FIGS. 4 to 8 were measured using 28 GHz as a frequency transmitted and received through the monopole antenna unit 200, and gains in the front of the glass 100 were measured.

Particularly, experiments were performed in the state in which the following data acquired included the same values as above except for only one variable factor. FIG. 4 shows gains in the front and at the rear of the glass 100 based on the thickness of the glass 100. As shown, experiments were performed using the thickness of the glass 100 as a variable factor, and it can be seen that, when the thickness of the glass 100 is 2.9 mm to 3.3 mm, the front gain value in a main irradiation direction is the maximum.

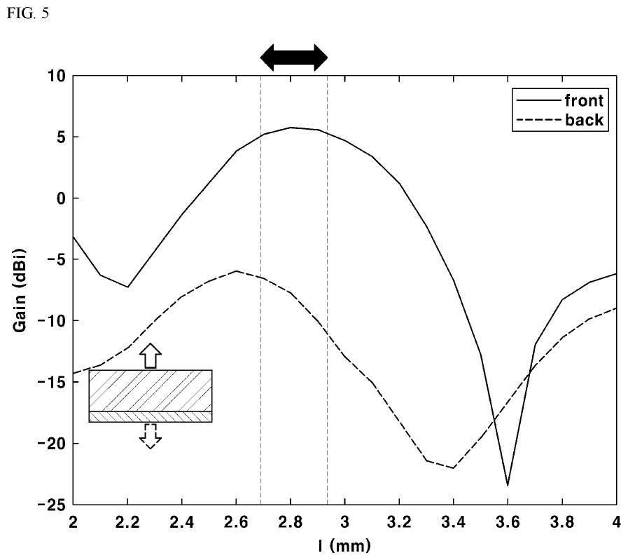

Furthermore, FIG. 5 shows front and back gain values corresponding to the first-direction length of the monopole device 210. As shown, when the first-direction length of the monopole device 210 is 2.7 mm to 2.9 mm, the maximum front gain value is acquired.

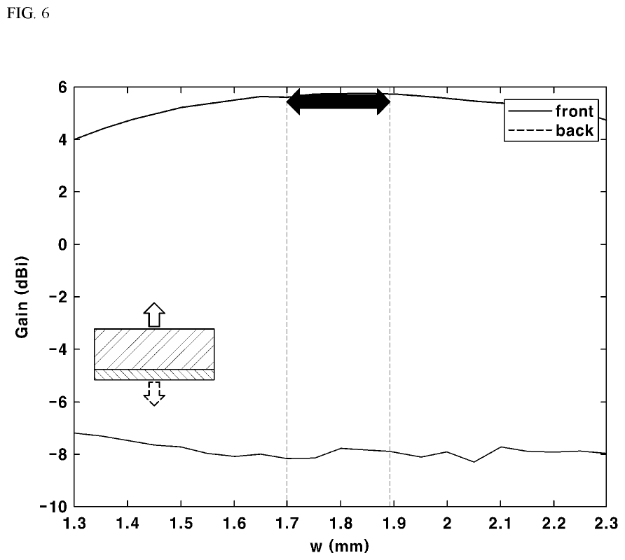

FIG. 6 shows front and back gain values corresponding to the second-direction length of the monopole device 210. As shown, when the second-direction length of the monopole device 210 is 2.7 mm to 2.9 mm, the maximum front gain value is acquired.

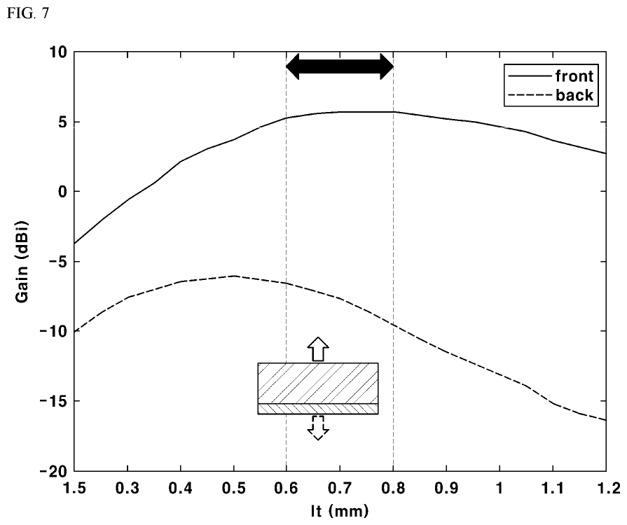

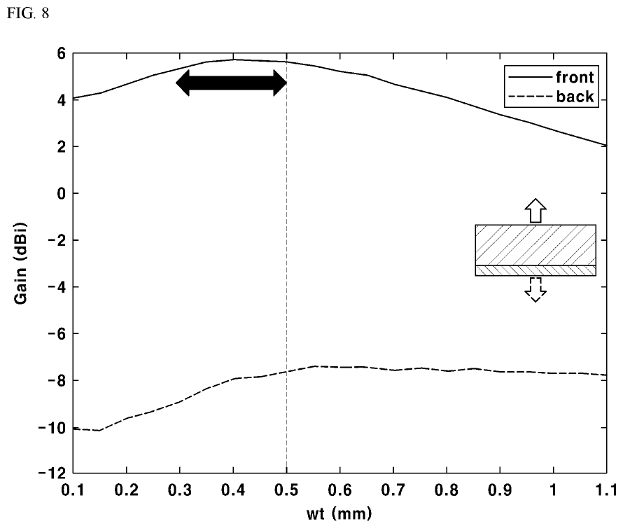

FIG. 7 shows gain data corresponding to the first-direction length of the transmission line 220 between the monopole devices 210, and FIG. 8 shows gain data corresponding to the second-direction width of the transmission line 220.

As shown in FIG. 7, when the first-direction length of the transmission line 220 between the monopole devices 210 is 0.8 mm or less, the gain is high. In other words, when the distance between the monopole devices 210 is 0.8 mm or less, the front gain properties are high. More preferably, when the length of the transmission line 220 disposed between the adjacent monopole devices 210 is 0.6 to 0.8 mm, the maximum gain may be obtained.

As shown in FIG. 8, when the second-direction width of the transmission line 220 is 0.3 mm to 0.5 mm, the front gain is the maximum. In conclusion, in an embodiment of the present invention, the single glass antenna structure 10 is configured such that the front gain is maximum based on the shape and dimensions of the monopole antenna unit 200 and the thickness of the glass 100 in response to a 5G frequency band.

As is apparent from the foregoing, the present invention may have the following effects from the construction, combination, and use of the embodiments described above. A transmission line configured to connect a plurality of single monopole devices disposed on one surface of a glass is provided, whereby it is possible to provide a high-safety antenna located at only a predetermined position of the glass. In addition, an optimized monopole device is provided, whereby it is possible to provide an antenna configured such that phase values of current resonating through a monopole antenna unit coincide with each other.

The above detailed description illustrates the present invention. In addition, the foregoing describes exemplary embodiments of the present invention. The present invention may be used in various different combinations, changes, and environments. That is, variations or modifications can be made within the conceptual scope of the present invention, equivalents to the disclosure of the present invention, and/or the scope of technology and knowledge in the art to which the present invention pertains. The embodiments describe the best mode for realizing the technical concept of the present invention, and variations required for the concrete application and use of the present invention are possible. Therefore, the above detailed description does not limit the present invention disclosed above. In addition, the appended claims should be interpreted to include other embodiments.

What is claimed is:

1. A single glass antenna structure, comprising:
a glass disposed on a vehicle; and
a plurality of monopole antenna units disposed on one surface of the glass to be adjacent to each other,
wherein each of the monopole antenna units includes:
a transmission line extending in a first direction of the glass; and
at least one monopole device disposed along the transmission line.

2. The single glass antenna structure according to claim 1, further comprising a connector located at one end of the transmission line.

3. The single glass antenna structure according to claim 1, further comprising a CPW-fed structure fastened to the connector.

4. The single glass antenna structure according to claim 1, further comprising a coating layer disposed on a rear surface of the glass, on which the monopole antenna units are printed.

5. The single glass antenna structure according to claim 1, wherein each of the monopole antenna units includes four monopole devices located along the transmission line to be spaced apart from each other by an identical distance.

6. The single glass antenna structure according to claim 1, wherein a second-direction width of the transmission line is a width of 0.3 mm to 0.5 mm of a second-direction width of the monopole device.

7. The single glass antenna structure according to claim 6, wherein a first-direction length of the monopole device is ⅓ or less of a wavelength of a frequency transmitted and received through the monopole antenna units.

8. The single glass antenna structure according to claim 1, wherein the glass has a thickness of 2.9 mm to 3.3 mm.

9. The single glass antenna structure according to claim 1, wherein the glass has a relative permittivity of 6.8 to 7.1.

10. The single glass antenna structure according to claim 1, wherein four monopole antenna units are disposed adjacent to each other to be spaced apart from each other by an identical distance.
